(19) United States
(12) Patent Application Publication
(10) Pub. No.: US 2023/0374707 A1
(43) Pub. Date: Nov. 23, 2023

(54) TEXTILE PART ADAPTED TO SUPPLY ELECTRIC CURRENT TO AN ELECTRONIC DEVICE OF A FASHION ITEM

(71) Applicant: The Swatch Group Research and Development Ltd, Marin (CH)

(72) Inventors: Nathalie MARINAKIS, Marin-Epagnier (CH); Nicolas FRANÇOIS, Neuchâtel (CH); Alain JORNOD, Neuchâtel (CH)

(73) Assignee: The Swatch Group Research and Development Ltd, Marin (CH)

(21) Appl. No.: 18/169,549

(22) Filed: Feb. 15, 2023

(30) Foreign Application Priority Data
May 20, 2022 (EP) 22174689.4

(51) Int. Cl. D03D 1/00; D03D 15/533

(52) U.S. Cl. CPC D03D 1/0088; D03D 15/533

(57) ABSTRACT

A textile part (10) including at least two textile layers superimposed on one another and each including fibres, the layers being formed by an energy-generating layer (11; 12) configured to generate an electric current from light radiation or from mechanical stresses, and an energy storage layer (13) for supplying an electronic device with an electric current, the storage layer (13) being electrically connected to the generating layer (11; 13) and configured to store the electric current.

### CROSS REFERENCE TO RELATED APPLICATIONS

The present application is based on, and claims priority from the prior European Patent Application No. 22174689.4, filed on May 20, 2022, the entire contents of which are incorporated herein by reference.

The invention relates as a whole to the field of portable electronic appliances, and in particular to the field of fashion items.

More particularly, the invention relates to a textile part adapted to generate an electric current, to store it and to power an electronic device of a fashion item.

The fashion item according to the invention is described herein through one of its preferred applications, wherein it takes the form of a strip, in particular strands of a bracelet intended to be worn on the wrist of a user.

### TECHNOLOGICAL BACKGROUND

Portable electronic appliances are supplied with electrical energy by an electrical energy source, such as a battery or cell.

Among electronic appliances, fashion items including an electronic device, such as glasses, headphones, bracelets and watches, etc., are often equipped with a rechargeable battery. One of the advantages of such a battery is that it does not need to be replaced when discharged, unlike a primary battery.

However, rechargeable batteries have the drawback that while they are being recharged, the portable electronic appliances that contain them are immobilised for varying lengths of time.

The present invention offers a solution to overcome this problem in particular.

More generally, the present invention provides a solution for generating and storing electrical energy in order to supply electric current to an electronic device of a fashion item.

### SUMMARY OF THE INVENTION

To this end, the present invention relates to a textile part including at least two textile layers superimposed on one another and each composed of fibres, said layers being formed by:
at least one energy-generating layer, referred to as the “inner generating layer”, configured to generate an electric current from mechanical stresses, and
an energy storage layer for supplying an electronic device with an electric current, said storage layer being electrically connected to the generating layer and configured to store the electric current.

Advantageously, the textile part comprises at least one excitation fibre including balls integral with a body of said fibre, said excitation fibre being woven with the inner generating layer. The term “integral” herein defines a connection between the balls and the body with or without degrees of freedom.

In particular embodiments, the invention can further include one or more of the following features, taken alone or according to any combination technically possible.

In particular embodiments, the textile part comprises an outer generating layer configured to generate an electric current from light radiation. The outer generating layer is superimposed on the inner generating layer, which in turn is superimposed on the storage layer, said outer and inner generating layers being electrically connected to the storage layer.

In particular embodiments, the outer generating layer comprises an array of fibres forming dye-sensitised solar cells and conductive fibres with which said solar cell-forming fibres are woven.

In particular embodiments, the inner generating layer is formed by an array of triboelectric nanogenerators comprising active assemblies woven with conductive fibres.

In particular embodiments, the storage layer is constituted by an array of fibres formed by batteries, each comprising a wire cathode and a wire anode.

According to another aspect, the present invention relates to a fashion item comprising a textile part and an electronic device configured to be supplied with electric current by the storage layer.

In particular embodiments, the storage layer includes an inductive coupling system in order to supply electric current to the electronic device.

According to yet another aspect, the present invention relates to a watch comprising a bracelet formed by at least one textile part as previously described, and an electronic or electromechanical horological movement to which the storage layer is connected in order to supply said horological movement with electric current.

### BRIEF DESCRIPTION OF THE FIGURES

Other features and advantages of the invention will become apparent upon reading the following detailed description given by way of a non-limiting example, and with reference to the accompanying drawings, in which:

FIG. 1 diagrammatically shows a sectional view of a textile part according to a preferred example embodiment of the present invention,

FIG. 2 diagrammatically shows an exploded view of the textile part in FIG. 1,

FIG. 3 diagrammatically shows a perspective view of an outer generating layer of the textile part in FIG. 1 according to an example embodiment of the invention,

FIG. 4 diagrammatically shows a sectional view of the outer generating layer in FIG. 3,

FIG. 5 diagrammatically shows a perspective view of an inner generating layer of the textile part in FIG. 1 in an example embodiment of the invention,

FIG. 6 diagrammatically shows a perspective view of a fibre of a storage layer of the textile part in FIG. 1 according to an example embodiment of the invention.

It should be noted that the figures are not to scale.

### DETAILED DESCRIPTION OF THE INVENTION

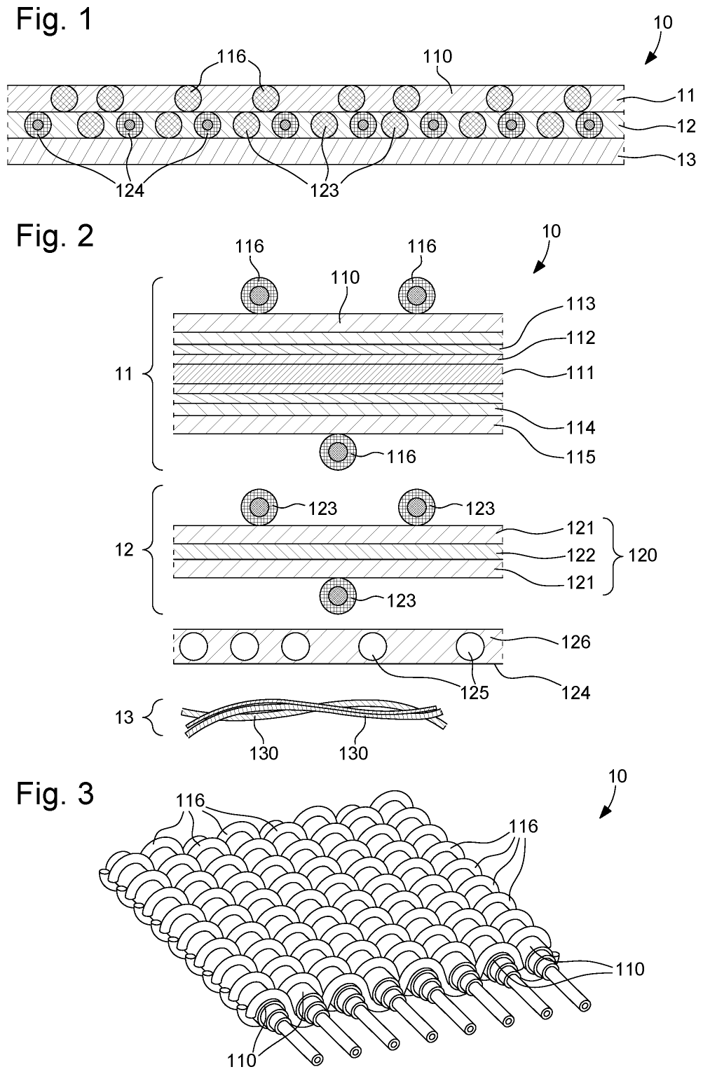

FIG. 1 shows a diagrammatic, sectional view of a textile part 10 according to the invention. This textile part 10 is intended to form part of a fashion item (not shown in the figures) that includes an electronic device intended to be supplied with an electric current.

The textile part 10 includes at least two textile layers superimposed on one another and each consisting of fibres. The term “fibre” is defined herein as a yarn-like and flexible, i.e. pliable, element.

In particular, the layers are formed at least by an electrical energy-generating layer 11, 12 configured to generate an electric current from light radiation or from mechanical stresses to which it is subjected, and by an energy storage layer 13 electrically connected to the generating layer 11, 12 and configured to store the electrical energy generated by said generating layer 11, 12.

In the preferred example embodiment of the present invention, the textile part 10 includes two generating layers 11 and 12, an outer generating layer 11 whereof being configured to generate an electric current from light radiation, and an inner generating layer 12 whereof being configured to generate an electric current from mechanical stresses to which it is subjected.

The relative terms “outer” and “inner” herein refer to the position of the layers relative to the external environment when the textile part 10 is in use, with the outer generating layer 11 being superimposed on the inner generating layer 12.

As shown in FIGS. 1 and 2, the inner generating layer 12 is superimposed on the storage layer 13. Advantageously, the outer generating layer 11 and inner generating layer 12 are electrically connected to said storage layer 13, so as to supply it with the electric current that they output.

The storage layer 13 is configured to supply the electronic device of the fashion item with an electric current for the operation thereof. The storage layer 13 can include an inductive coupling system to transmit energy wirelessly to the electronic device or can be connected by dedicated fibres.

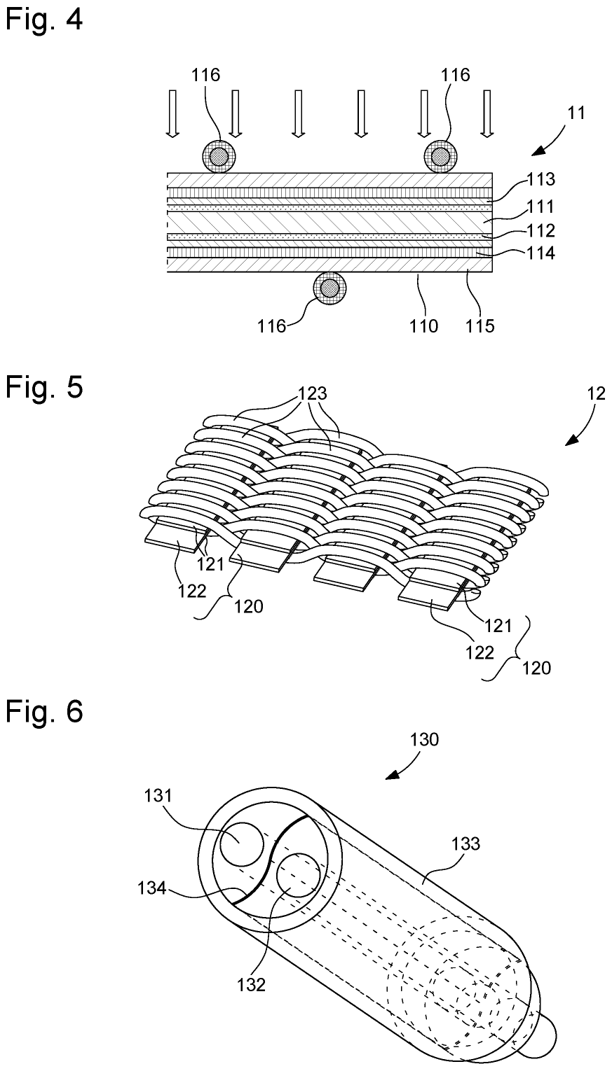

Preferably, the outer generating layer 11 comprises an array of fibres forming dye-sensitised solar cells 110, also known by a person skilled in the art by the acronym “DSSC”. The solar cells 110 are shown in detail in FIGS. 3 and 4 and are intended to be subjected to light radiation represented by arrows in FIG. 4.

As shown in FIGS. 2 and 4, each fibre of the outer generating layer 11 forming a solar cell 110 comprises, in the preferred example embodiment of the invention, a polymer yarn 111, preferably made of polybutylene terephthalate, coated with a thin layer of copper 112, for example having a thickness of between 0.2 and 0.3 millimetres. The thin layer of copper 112 is covered with a layer of manganese 113, which in turn is covered with a layer of a semiconductor material 114, such as zinc oxide, sensitised with a chromophore chosen, for example, from among ruthenium polypyridyl complexes, such as N719. The layers of copper 112 and of semiconductor material 114 are intended to form the anode of the solar cell 110. The layer of semiconductor material 114 is covered with a hole transport layer 115, for example made of copper iodide.

The outer generating layer 11 further includes conductive fibres 116 forming cathodes, with which the fibres constituting solar cells 110 are woven, as shown in particular in FIGS. 2 to 4. The conductive fibres are preferably made of copper or aluminium, or more generally of any suitable electrically-conductive material.

The outer generating layer 11 can be configured such that the fibres constituting the solar cells 110 are arranged in series, thereby increasing the voltage generated by the solar cells 110. Alternatively, the outer generating layer 11 can be configured such that the fibres constituting the solar cells 110 are arranged in parallel, thereby increasing the current output by the solar cells 110.

In other example embodiments of the invention, the solar cells 110 can be of the organic solar cell type, also known by a person skilled in the art as “OPVC” or “Organic Photovoltaic Cells”, of the multijunction concentrator solar cell type.

In the preferred example embodiment of the invention, the inner generating layer 12 comprises an array of triboelectric nanogenerators, also known as “TENG”, as shown in FIG. 5.

More specifically, the plurality of triboelectric nanogenerators comprises active assemblies 120 in the form of blades composed of two leaves of polytetrafluoroethylene 121, also known by a person skilled in the art by the acronym “PTFE”, superimposed on one another and between which is sandwiched an electrically conductive leaf 122. The triboelectric nanogenerators further include conductive fibres 123 with which the active assemblies 120 are woven, as shown in FIGS. 2 and 5. The PTFE leaves 121 constitute electrodes of the inner generating layer 12.

The leaf 122 is preferably made of copper, and can generally speaking be made of any suitable electrically conductive material.

The active assemblies 120 are capable of moving relative to the conductive fibres 123. The rubbing of the PTFE leaves 121 against the conductive fibres 123 generates an electric current output.

Advantageously, the conductive leaf 122 has at least one degree of mobility relative to the polytetrafluoroethylene leaves 121, so as to increase the electric current output.

For example, the inner generating layer 12 can include about twenty active assemblies 120. Furthermore, the PTFE 121 and conductive 122 leaves can be a few tens of micrometres thick, for example about 30 micrometres thick, as can the diameter of the conductive fibres 123.

In other example embodiments of the invention, the active assemblies 120 can have a tubular shape with a circular cross-section, and be formed by a tubular copper core encased in a PTFE tube.

When the textile part 10 is subjected to a mechanical stress tending to deform it, for example a bending, twisting, compressive or tensile stress, the difference in electron affinity between the copper and the PTFE will result in a charge transfer which will lead to the conductive fibres 123 being positively charged and the PTFE leaves 121 being negatively charged. When the mechanical stressing of the textile part 10 ceases, the charge separation between the conductive fibres 123 and the PTFE leaves 121 caused by the mechanical deformation results in a flow of electrons from the PTFE leaves 121 to the conductive fibres 123.

Advantageously, the inner generating layer 12 is subject to greater mechanical stress due to its arrangement between the outer generating layer 11 and the storage layer 13, and thus has a relatively high electric current output. More particularly, the inner generating layer 12 is subject to friction generated by both the outer generating layer 11 and by the storage layer 13 when the textile part 10 is deformed.

Advantageously, in order to further increase the energy efficiency of the textile part 10, excitation fibres 124, each including balls 125 that are capable of moving relative to a body 126 of said fibre, are woven with the inner generating layer 12.

The balls 125 of the excitation fibres 124 can alternatively be fixed without any degree of freedom relative to the body 126.

The excitation fibre 124 is configured to increase the stresses on the inner generating layer 12.

The balls 125 can be arranged in the body 126, which thus has a hollow tubular shape, as shown diagrammatically in FIG. 2.

Moreover, the inner generating layer 12 comprises an array of components with thermoelectric properties so as to form a thermoelectric generator.

In further example embodiments of the invention, the inner generating layer 12 can also comprise an array of components with piezoelectric properties.

Thanks to the combination of the outer generating layer 11 and inner generating layer 12, the energy output of the textile part 10 can be relatively high in relation to the electric current required to power the electronic device, in particular in an application of the present invention wherein the textile part 10 forms a strand of a bracelet of a watch and wherein the electronic device is an electronic or electromechanical horological movement of the watch.

The textile part 10 could also include a plurality of inner generating layers 12. In particular, in an alternative preferred example embodiment of the invention, two inner generating layers 12, each comprising an array of triboelectric nanogenerators, can be superimposed on one another to increase the current output of the textile part 10.

In one example embodiment of the invention, the storage layer 13 consists of an array of fibres formed by batteries 130, each comprising a wire cathode 131 made from carbon nanotubes combined with lithium iron phosphate powder, and a wire anode 132 made from carbon nanotubes combined with lithium titanate powder. As shown in FIG. 6, the anode 132 and the cathode 131 are each twisted and are coated together in a gelled electrolyte within a heat-shrinkable sheath 133 forming the body of the fibre. The anode 132 and the cathode 131 are separated from one another by a separator element 134.

In another example embodiment of the invention, the cathode 131 and the anode 132 can respectively be formed by lithium titanate powder and lithium manganese powder on a multi-walled carbon nanotube substrate. By way of example, the diameter of the cathode 131 and that of the anode 132 are approximately 130 and 70 micrometers respectively.

The storage layer 13 can include about ten batteries 130. Such a number of batteries is particularly suitable for storing and releasing electrical energy to power an electronic or electromechanical horological movement of a watch.

The storage layer 13 is electrically connected to each of the outer generating layer 11 and inner generating layer 12 so as to be charged with electric current thereby. The storage layer 13 is also electrically connected to the electronic device so that it can supply electric current thereto by discharging.

Advantageously, the fibres formed by batteries 130 are woven or knitted with one another, and/or with the inner generating layer 12.

In the preferred example embodiment of the invention, the textile part 10 can have a thickness of a few millimetres, for example 2 millimetres. The textile part 10 can include structural fibres, for example made of polymer, woven with the outer generating layer 11 and inner generating layer 12 and the storage layer 13 in order to make said layers integral with one another.

In an advantageous application of the present invention, the fashion item of which the textile part 10 is intended to be a part is a watch including an electronic or electromechanical horological movement intended to be supplied with an electric current.

The watch comprises a bracelet formed by at least one textile part 10, and the horological movement is connected to the storage layer 13 in order to be supplied with electric current in order to operate. More particularly, by way of example, the bracelet can include two strands, each formed by a textile part 10, each of the strands being connected to the movement.

In one example embodiment of the invention, each strand includes connectors at the proximal end thereof, i.e. at the end via which the strand is intended to be fixed to a watch case, which connectors are connected to the storage layer 13. In a complementary manner, the watch includes a case on the edge of which case connectors emerge which are intended to be arranged such that they face the connectors of each of the strands such that the latter rest against said case connectors respectively.

When the watch is worn by a user, the outer generating layer 11 is thus the layer located the closest to the external environment and the storage layer 13 is the layer located the closest to the user.

The invention is described in the context of an application of the invention to a fashion item formed by a watch. However, it goes without saying that the invention is not limited to this application and could advantageously be used with any other fashion item that includes an electronic device.

Generally speaking, it should be noted that the implementations and embodiments considered hereinabove have been described by way of non-limiting examples, and that other alternative implementations and embodiments can thus be envisaged.

1. A textile part including at least two textile layers superimposed on one another and each including fibres, said layers being formed by:
an inner generating layer configured to generate an electric current from mechanical stresses; and
an energy storage layer for supplying an electronic device with an electric current, said storage layer being electrically connected to the inner generating layer and configured to store the electric current output thereby;
said textile part further comprising an excitation fibre including balls integral with a body of said fibre, said excitation fibre being woven with the inner generating layer.

2. The textile part according to claim 1, further comprising an outer generating layer configured to generate an electric current from light radiation, the outer generating layer being superimposed on the inner generating layer, which is superimposed on the storage layer, said outer generating layer and inner generating layer being electrically connected to the storage layer.

3. The textile part according to claim 2, wherein the outer generating layer comprises an array of fibres forming dye-sensitised solar cells and conductive fibres with which said solar cell-forming fibres are woven.

4. The textile part according to claim 2, wherein the inner generating layer is formed by an array of triboelectric nanogenerators comprising active assemblies woven with conductive fibres.

5. The textile part according to claim 1, wherein the storage layer is constituted by an array of fibres formed by batteries, each comprising a wire cathode and a wire anode.

6. A fashion item, comprising a textile part according to claim 1, and an electronic device configured to be supplied with electric current by the storage layer.

7. The fashion item according to claim 6, wherein the storage layer includes an inductive coupling system in order to supply electric current to the electronic device.

8. A watch, comprising a bracelet formed by at least one textile part according to claim 1, and an electronic or electromechanical horological movement to which the storage layer is connected in order to supply said horological movement with an electric current.
